(19) United States
(12) Patent Application Publication
(10) Pub. No.: US 2015/0283711 A1
(43) Pub. Date: Oct. 8, 2015

(54) FOOD SLOTTING DEVICE AND METHOD

(71) Applicant: DANIEL JOHN CRICHTON, BURLINGTON (CA)

(72) Inventor: DANIEL JOHN CRICHTON, BURLINGTON (CA)

(21) Appl. No.: 14/673,875

(22) Filed: Mar. 31, 2015

Related U.S. Application Data
(60) Provisional application No. 61/973,843, filed on Apr. 2, 2014.

(51) Int. Cl. B26B 3/04; A47J 37/07; A47J 43/28; B26D 3/08

(52) U.S. Cl. CPC B26B 3/04; B26D 3/08; A47J 37/0786; A47J 43/28; B26D 2210/02

(57) ABSTRACT

A FOOD SLOTTING DEVICE comprised of a holding unit, an assembly of slicing blades arranged in a perpendicular fashion, and an affixed cover piece, for creating an elongated cross-hatch pattern of perpendicular slots by partially slicing into one or more surface areas on the body of a food product, generally of an elongated nature, such as a hot dog, wiener, frankfurter, sausage or the like through the directional application of force, such as the METHOD of carrying out such partial slicing denotes. Thereafter the partially sliced food product is easily removed from the slicing blades assembly of the FOOD SLOTTING DEVICE prior to cooking, grilling, or further processing. Said slots prevent bursting by permitting gases generated by the cooking process to escape, allowing penetration of the heat to the center of the food product providing quicker cooking thereof, thereby providing for a more palatable and pleasant looking food product.

### BACKGROUND

It is desirable to provide a simple to use device for creating slots by partially slicing into food products that are generally elongated in nature, more particularly hot dogs, sausages and similar, without external casing, or encased in synthetic or natural membrane type casings. It is also desirable to make said slots in one or multiple sides of said food products in a crosshatch pattern, with the cuts placed perpendicular to one another, evenly spaced out along the full longitudinal area of the food product, prior to the cooking, grilling, or further processing of the food product. As an example relating to hot dogs, wieners, frankfurters, sausages or the like, in the cooking or grilling process the cook will make a plurality of angular slices along the individual food item prior to placing the food item on the grill so as to prevent the food item from burning, drying out, becoming overcooked, or to permit the escape of gases generated by the cooking or grilling process in order to prevent bursting, and said slices also allow more rapid penetration of the heat to the center of the food product to provide more rapid cooking thereof. While such slices may be made in a manual manner, using a knife by hand for example, or by a complicated processing machine, it is desirable to provide for a simple to use, cost effective, time efficient, and portable device in order to make, as desired, partial cuts to a food product, such as a hot dog, wiener, frankfurter, sausage or the like.

### BRIEF SUMMARY OF THE INVENTION

This invention relates to a FOOD SLOTTING DEVICE for creating perpendicular slots by partially slicing into a food product of a generally elongated nature, such as a hot dog, wiener, frankfurter, sausage or the like, and to a method of carrying out such partial slicing.

A simple to use, cost effective, time efficient, and easily portable device has been discovered for making, in a simple and effective manner, perpendicular slots by partially slicing into the body of a generally elongated food product, such as a hot dog, wiener, frankfurter, sausage or the like. The FOOD SLOTTING DEVICE typically comprises of a plurality of slicing blades each of a defined height as to affect the desired depth of slot sliced into the body of the food product assembled in a slicing blades assembly of defined relation. The slicing blade height is designed to slice into the food product not greater than approximately fifty percent, or preferably in between fifty percent and ten percent of the relative thickness of the food product when the device is fully applied with directional force to the food product, so that the food product is then easily removed from the FOOD SLOTTING DEVICE for cooking or further processing. The slicing blades in the slicing blades assembly are assembled in a perpendicular relation to one another, forming an elongated equally spaced cross-hatch pattern, housed within a holding unit comprised of plastic or similarly rigid material, the slicing blades assembly being secured in place within the holding unit by a cover piece comprised of a generally similar material to that of the holding unit, affixed in place to the holding unit by friction and/or the use of an adhesive.

The FOOD SLOTTING DEVICE may be made entirely of plastic, metal, or any combination of similarly rigid materials as mentioned above, for example a plastic holding unit with metal slicing blades assembly, or a metal holding unit with metal slicing blades assembly. The slicing blades assembly made of metal, plastic or a similarly rigid material slicing blades may be affixed within the holding unit by adhesive and/or friction, welded, molded in position, or bent from a portion of the body. The FOOD SLOTTING DEVICE is cost effective and simple to use in order to create slots by partially slicing into a food product, in a rapid and efficient manner so that the food product may then be cooked in a more consistent manner without uncontrollable bursting of the outer casing or skin if it exists, by permitting the escape of gases generated by the cooking process, and said slots also allow more rapid penetration of the heat to the center of the food product to provide more rapid cooking thereof, thereby providing for a more palatable and pleasant looking food product such as a hot dog, wiener, frankfurter, sausage or the like upon cooking or grilling.

The method of the invention comprises placing a generally elongated food product to be partially sliced, onto a flat surface, then with the slicing blades assembly component of the FOOD SLOTTING DEVICE contacting the surface of the food product, applying directional force such as downward, upwards, sideways or horizontal for example, as desired directly onto the food product, with a FOOD SLOTTING DEVICE comprising of a holding unit section and housing an affixed assembly of perpendicular slicing blades extending a sufficient distance to effect the partial slots in the number and depth as desired by pressing the assembled FOOD SLOTTING DEVICE in the desired direction upon one or multiple longitudinal sides of the food product, so as to cause the slicing blades to penetrate the food product to a desired depth creating a cross-hatch pattern of slots on the food product, and thereafter easily remove the partially sliced food product from the slicing blades of the FOOD SLOTTING DEVICE prior to cooking, grilling, or further processing.

### BRIEF DESCRIPTION OF THE DRAWINGS

FIG. 1 is a bottom perspective view of the completely assembled FOOD SLOTTING DEVICE constructed in accordance with the teachings of the instant invention.

FIG. 2 is a perspective view demonstrating the motion of applying the FOOD SLOTTING DEVICE via directional force to a food product, for example in a vertical downward motion.

FIG. 3 is an exploded perspective view of the three individual components of the FOOD SLOTTING DEVICE.

FIG. 4 is an exploded bottom plan view of the three individual components of the FOOD SLOTTING DEVICE.

FIG. 5 is an enlarged broken away view of the assembled slicing blades assembly housed within the holding unit.

### DETAILED DESCRIPTION OF THE PREFERRED EMBODIMENT(S)

The invention will be described for the purposes of illustration only in connection with certain preferred embodiments; however, it is recognized that those people skilled in the art may make various changes, modifications, additions and improvements to the preferred and illustrated embodiment, all falling within the spirit and scope of the invention.

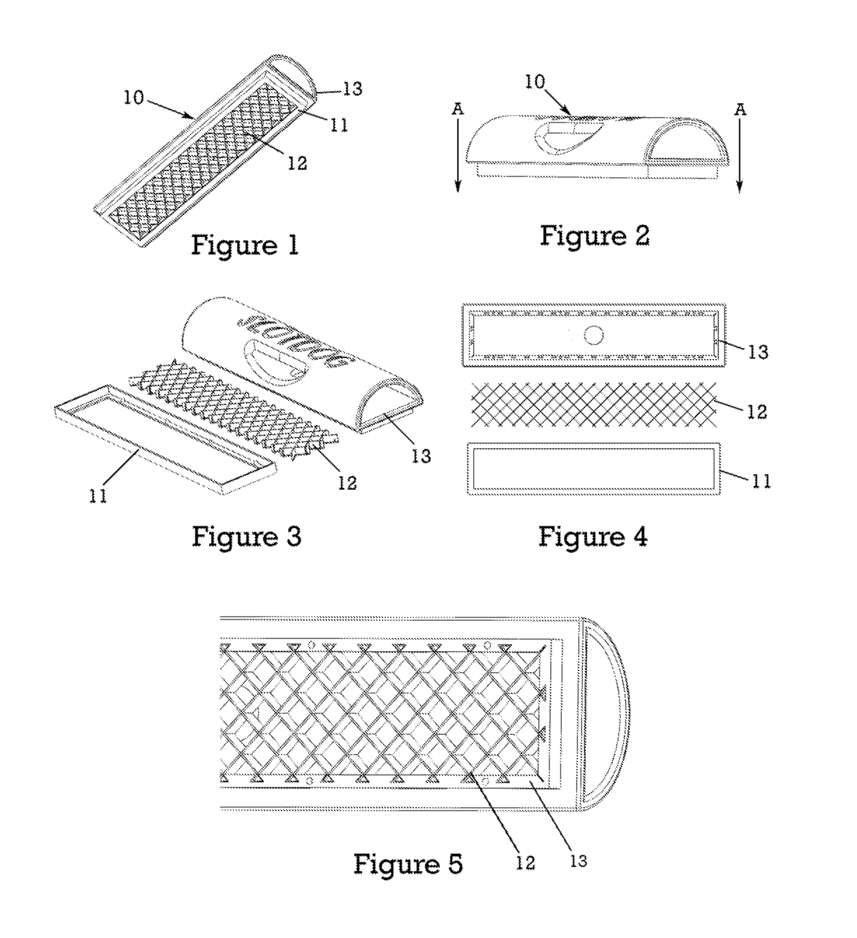

Turning now to the drawings, in which like reference characters indicate corresponding elements, attention is first directed to FIG. 1 in which is seen a FOOD SLOTTING DEVICE 10 from a bottom perspective view of the completely assembled FOOD SLOTTING DEVICE 10 constructed in accordance with the teachings of the instant invention, generally designated by the reference character 10, with the cover piece 11 affixed in place to the holding unit 13 through the utilization of adhesive and friction, securing the slicing blades assembly 12 within the holding unit 13. As illustrated, the slicing blades assembly 12 is positioned to affect, by slicing via the use of force, an elongated equally spaced cross-hatch pattern of slots with depths in the range of approximately 10-50% of the relative thickness of the food product. The slicing blades in the slicing blades assembly 12 are shown to possess a straight, linear edged design, however, if desired can be of curved or any other similar edge shape.

FIG. 2 is a perspective view demonstrating one of the suggested motions regarding the method of effecting partial slots by the applying the FOOD SLOTTING DEVICE through the directional application of force to a food product, in this example, in the downward motion direction of arrowed lines A. The method of the invention comprises placing a generally elongated food product to be partially sliced, such as a hot dog for example, onto a flat surface, then with the slicing blades assembly 12 component of the FOOD SLOTTING DEVICE 10 contacting the surface of the food product, applying directional force downwards, upwards, sideways or horizontally as desired, directly onto the food product, with a FOOD SLOTTING DEVICE 10 comprising of a holding unit 13 section and housing an affixed slicing blades assembly 12 of perpendicular slicing blades extending a sufficient distance to effect the partial slots in the number and depth as desired by pressing the assembled FOOD SLOTTING DEVICE 10 in the desired direction upon one or multiple longitudinal sides of the food product, so as to cause the slicing blades assembly 12 to penetrate the surface, skin, or membrane of the food product to a desired depth creating an elongated equally spaced cross-hatch pattern of slots on the food product, and thereafter easily remove the partially sliced food product from the slicing blades assembly 12 of the FOOD SLOTTING DEVICE 10 prior to cooking, grilling, or further processing.

FIG. 3 is an exploded perspective view of the three individual components of the FOOD SLOTTING DEVICE: the cover piece 11 which utilizes adhesive and friction to adhere to the holding unit 13 in order to affix the slicing blades assembly 12 in place, slicing blades assembly 12 with a plurality of slicing blades assembled in a perpendicular relation to one another forming an elongated equally spaced cross-hatch pattern, and the holding unit 13.

FIG. 4 is an exploded bottom plan view of the three individual components of the FOOD SLOTTING DEVICE: holding unit 13 with a view of the recessed section created to accommodate the slicing blades assembly 12, the slicing blades assembly 12 with slicing blades assembled in a perpendicular relation to one another forming an elongated equally spaced cross- hatch pattern, and the cover piece 11 which utilizes a combination of adhesive and friction due to precise fitment to hold the slicing blades assembly 12 in place.

FIG. 5 is an enlarged broken away view of the slicing blades assembly 12 housed within the holding unit 13, utilizing the recessed section of the holding unit 13 to create a precise fit, prior to the cover piece 11 being affixed to the holding unit 13 as described.

The FOOD SLOTTING DEVICE 10 as described may be made entirely of plastic, metal, or any combination of similarly rigid materials as mentioned above, for example a plastic holding unit 13 with metal slicing blades assembly 12 and plastic cover piece 11, or a metal holding unit 13 with metal slicing blades assembly 12 and metal cover piece 11. The slicing blades assembly 12 made of metal, plastic or a similarly rigid material may be affixed within the holding unit 10 by adhesive and/or friction, welded, molded in position, or bent from a portion of the body of the holding unit 13 or similar itself, thus possibly negating the need for a cover piece 11 in some other embodiment situations.

The FOOD SLOTTING DEVICE 10 as illustrated and described provides for a simple to use, cost effective, time efficient, and easily portable device to create perpendicular slots by partially slicing into the body of a generally elongated food product, such as a hot dog, wiener, frankfurter, sausage or the like.

I claim:

1. A device for partially slicing into one or more surface areas on the body of an article of food generally elongated in nature, such as a hot dog, wiener, frankfurter, sausage or the like comprising:
a. A holding unit; and
b. An assembly of slicing blades.

2. A device as recited in claim 1, wherein said holding unit is formed from a rigid material such as plastic or metal, to which said assembly of slicing blades is connected.

3. A device as recited in claim 1, wherein said holding unit comprises a cavity designed to receive said assembly of slicing blades.

4. A device as recited in claim 1, wherein said assembly of slicing blades comprises a plurality of individual slicing blades formed from a rigid material such as plastic or metal alloy.

5. A device as recited in claim 1, wherein said assembly of slicing blades comprises a plurality of individual slicing blades assembled in such a manner as to create a cross-hatched pattern of slicing blades.

6. A device as recited in claim 1, wherein said assembly of slicing blades is connected to said holding unit by the presence of friction existing between said holding unit and said assembly of slicing blades.

7. A device as recited in claim 1, wherein said assembly of slicing blades is connected to said holding unit by a cover piece through the presence of friction existing between said holding unit and said cover piece.

8. A device as recited in claim 1, wherein said assembly of slicing blades is connected to said holding unit by a cover piece through the presence of adhesive applied to opposing surfaces of said holding unit and said cover piece.

9. A device as recited in claim 1, wherein said assembly of slicing blades is connected to said holding unit by welding said components.

10. A device as recited in claim 1, wherein said assembly of slicing blades is molded or bent from a portion of the body of said holding unit.

11. A device as recited in claim 1, wherein said assembly of slicing blades and said holding unit are formed together as a single entity.

12. A method for slicing into one or more surface areas on the body of an article of food comprising;
a. An article of food generally elongated in nature, such as a hot dog, wiener, frankfurter, sausage or the like;
b. A device comprising a slicing component;
c. The slicing component of said device contacting the surface of said article of food;
d. Applying force through said device to said article of food causing said slicing component to effect slices into the surface area of said article of food; and
e. Separating said article of food from said slicing component of said device for cooking, heating, or further processing.

13. The method as recited in claim 8, further comprising placing said article of food onto an even surface.

14. The method as recited in claim 8, wherein said device is applied to one or multiple longitudinal sides of said article of food.

15. The method as recited in claim 8, wherein said slicing component penetrates the surface, skin, or membrane of said article of food to a desired depth generally between 10% and 50% of the overall thickness of said article of food so as to not cut completely through said article of food.

16. The method as recited in claim 8, wherein a cross-hatch pattern of slices equally referred to as slots is created in the body of said article of food.

17. The method as recited in claim 8, wherein said article of food becomes lodged in said slicing component of said device to be easily removed with minimal force required.
